(19) United States
(12) Patent Application Publication
(10) Pub. No.: US 2011/0278778 A1
(43) Pub. Date: Nov. 17, 2011

(54) Self Centering Spring Linkage

(76) Inventor: Jamal Umar Qattan, San Diego, CA (US)

(21) Appl. No.: 12/779,716

(22) Filed: May 13, 2010

(51) Int. Cl. F16F 7/00; F16F 6/00; F16F 1/06

(52) U.S. Cl. 267/151; 267/171

(57) ABSTRACT

Methods and apparatus for a bi-directional self-centering linkage are provided. The bi-directional self-centering linkage contains a compression spring sliding shaft assembly that may be pre-loaded to a predetermined calculated value. The bi-directional self-centering linkage is adjusted and then installed to connect with an outside mechanical device that transmits a force to the bi-directional self-centering linkage. The compression spring sliding shaft assembly either transmits or dampens the force applied. An alternate embodiment provides electromagnetic actuation.

### BACKGROUND

1. Field

The present disclosure relates generally to mechanical devices, and, in particular, to an apparatus and method for a self-centering spring linkage.

2. Background

Mechanical linkages are among the oldest devices used by man. A linkage may be a simple series of rigid links connected with joints to form a closed chain. A very simple linkage is found on steam locomotives, and transmits power to the wheels of the train. Other linkages may guide rotary motion for windmills and pumps.

Linkages of various types are used in pumps, scales, lifting devices, bolt cutters, bicycles, and motorcycles. The most common use of a linkage is as part of a vehicle suspension. The linkage is used to provide improved road handling and to isolate the vehicle occupants from road noise, bumps, and uneven terrain.

As vehicles have become more complex, so have suspension linkages, such as shock absorbers. The linkages incorporate springs to control the excursion of the vehicle's wheels. Other linkages utilize magnetic forces in place of the compression springs.

In the past, linkages have relied on uni-directional spring action that may not be suitable for all situations. In particular, linkages have not provided self-centering mechanisms to optimize linkage performance. Past linkage designs have relied on two opposing compression springs. There is a need in the art for a bi-directional self-centering linkage utilizing a single compression spring device.

### SUMMARY

A bi-directional self-centering linkage is provided. The bi-directional self-centering linkage includes a linkage lower body sub-assembly and a linkage upper body sub-assembly. The linkage upper body sub-assembly contains a compression spring sliding shaft inside a housing. The linkage lower body sub-assembly is connected to the linkage upper body sub-assembly to form the bi-directional self-centering linkage. The bi-directional self-centering linkage has attachment points at the free ends to allow for mounting to external mechanical devices during use.

A further embodiment provides an electromagnetic version of the bi-directional self-centering linkage. This embodiment also contains a linkage lower body sub-assembly. A linkage upper body sub-assembly contains an electromagnetically activated sliding shaft sub-assembly and a linkage electrical parts assembly capable of being connected to an electrical power source. The linkage lower body sub-assembly is connected to the linkage upper body sub-assembly. Attachment points are provided at the free ends of the electromagnetically activated bi-directional self-centering linkage for mounting to an external mechanical device. The external mechanical device applies a mechanical force to the installed linkage in operation.

A bi-directional self-centering linkage apparatus is provided. The apparatus consists of means for compressing a spring to a calculated pre-load height; means for adjusting a sliding shaft sub-assembly height to match the pre-load height inside a bi-directional self-centering linkage body; means for adjusting a nut until the spring is extended inside the bi-directional self-centering linkage without backlash; and means for installing the bi-directional self-centering linkage.

A bi-directional self-centering linkage apparatus is provided. The apparatus comprises: means for compressing the spring to a calculated pre-load height with no electric current source applied for electromagnetic bushings and fixed electromagnets; means for adjusting the pre-load height by activating the electromagnets to adjust an attraction or repulsion force to a predetermined value; and means for attaching or installing the bi-directional self-centering electromagnetic linkage.

Various aspects and embodiments of the invention are described in further detail below.

### BRIEF DESCRIPTION OF THE DRAWINGS

FIG. 1 is an illustration of the bi-directional self-centering spring linkage, in accordance with various embodiments of the present invention.

FIG. 2 is an illustration of the component assemblies of the bi-directional self-centering spring linkage, in accordance with one or more embodiments the present invention.

FIG. 3 is an illustration of the linkage lower body sub-assembly, according to one or more embodiments of the present invention.

FIG. 4 is an illustration of the linkage upper body sub-assembly, according to one or more embodiments of the present invention.

FIG. 5 is an illustration of the linkage compression spring sliding shaft sub-assembly, according to one or more embodiments of the present invention.

FIG. 6 shows the linkage compression spring sliding shaft sub-assembly in unloaded, pre-loaded, and assembled states, according to one or more embodiments of the present invention.

FIG. 7 shows the bi-directional linkage assembly in an overloaded compressed state, a static state, and an unloaded state, according to one or more embodiments of the present invention.

FIG. 8 shows the bi-directional linkage assembly in an overloaded extended state, a static state, and an unloaded state, according to one or more embodiments of the invention.

FIG. 9 illustrates a bi-directional self-centering linkage with magnetic actuation, according to one or more embodiments of the present invention.

FIG. 10 illustrates the major sub-assemblies of a bi-directional self-centering magnetic linkage, according to one or more embodiments of the present invention.

FIG. 11 shows the bi-directional self-centering linkage with magnetic actuation in compression, according to one or more embodiments of the present invention.

FIG. 12 shows the bi-directional self-centering linkage with magnetic actuation in tension, according to one or more embodiments of the present invention.

FIG. 13 illustrates alternative housing shapes, according to one or more embodiments of the present invention.

FIG. 14 illustrates the bi-directional self-centering linkage with load cells placed within the housing, according to one or more embodiments of the present invention.

FIG. 15 provides a cut-away view of the bi-directional self-centering linkage with load cells within the housing, according to one or more embodiments of the present invention.

### DETAILED DESCRIPTION

Various embodiments are now described with reference to the drawings, wherein like reference numerals are used to refer to like elements throughout. In the following description, for purposes of explanation, numerous specific details are set forth in order to provide a thorough understanding of one or more embodiments. It may be evident, however, that such embodiment(s) may be practiced without these specific details. In other instances, well-known structures and devices are shown in block diagram form in order to facilitate describing one or more embodiments.

In the following paragraphs, the present invention will be described in detail by way of example with reference to the attached drawings. Throughout this description, the preferred embodiment and examples shown should be considered as exemplars, rather than as limitations on the present invention. As used herein, the “present invention” refers to any one of the embodiments of the invention described herein, and any equivalents. Furthermore, reference to various feature(s) of the “present invention” throughout this document does not mean that all claimed embodiments or methods must include the referenced feature(s).

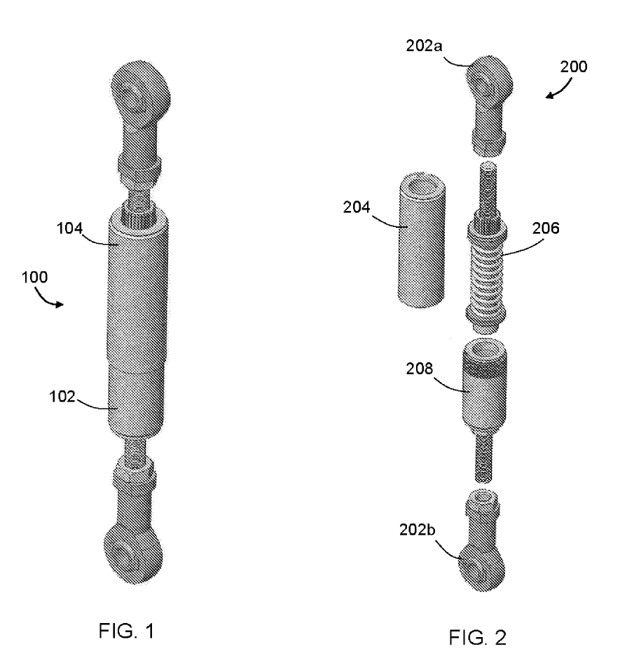

FIG. 1 shows a bi-directional self-centering spring linkage according to an embodiment. The bi-directional self-centering spring linkage 100 may be comprised of several sub-assemblies. Typically, these sub-assemblies are the linkage lower body sub-assembly 102, the linkage upper body sub-assembly 104, and the linkage compression spring sliding sub-assembly 206, shown in FIG. 2.

FIG. 2 illustrates a partial exploded view of the bi-directional self-centering spring linkage 100. The partial exploded view 200 shows the ball joint ends 202a and 202b for attachment to fixed points that tie the bi-directional self-centering spring linkage to outside mechanical assemblies. The connection to external devices is not limited to ball joints. The lower housing may also be fixed to a base member with the compression spring element attached to a different external mechanical element. The upper body sub-weldment 204 shields the compression spring sliding shaft sub-assembly 206 from the elements. Lower body sub-weldment 208 attaches to the lower end of the compression spring sliding shaft sub-assembly 206, shielded by upper body sub-weldment 204.

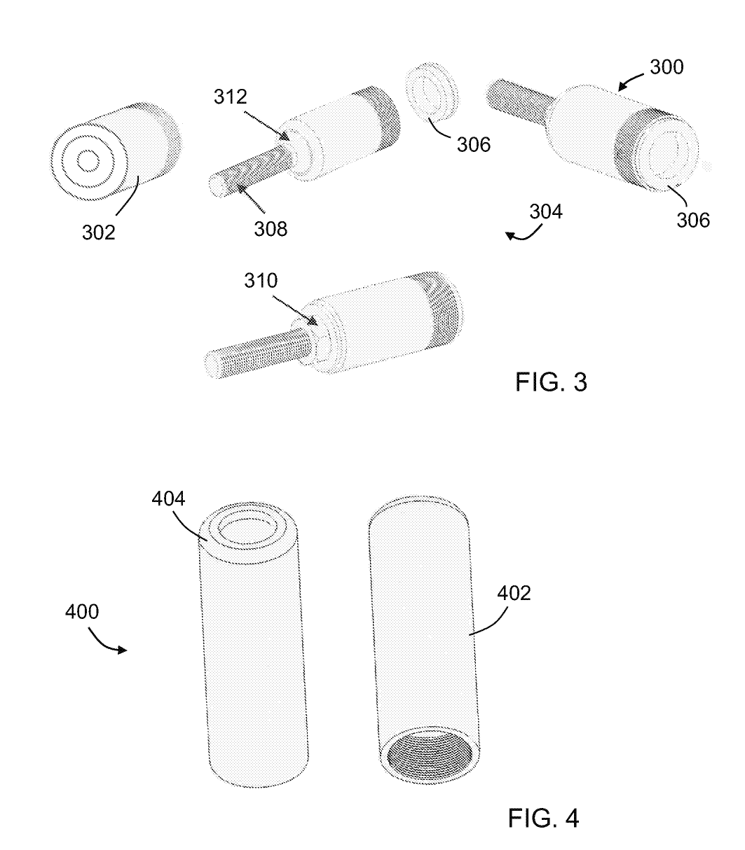

FIG. 3 provides a detailed, exploded view of the linkage lower body sub-assembly 102. The linkage lower body sub-assembly consists of a lower housing 302, top end washer 304, lower end washer 306, threaded rod 308, and jam nut 310 or weld 312. The jam nut 310 may be replaced by a weld 312. While FIG. 3 illustrates both jam nut 310 and weld 312, it is to be understood that either may be used, and not both. One embodiment may utilize jam nut 310 and a separate embodiment may utilize weld 312, without adversely affecting the function of the bi-directional self-centering spring linkage.

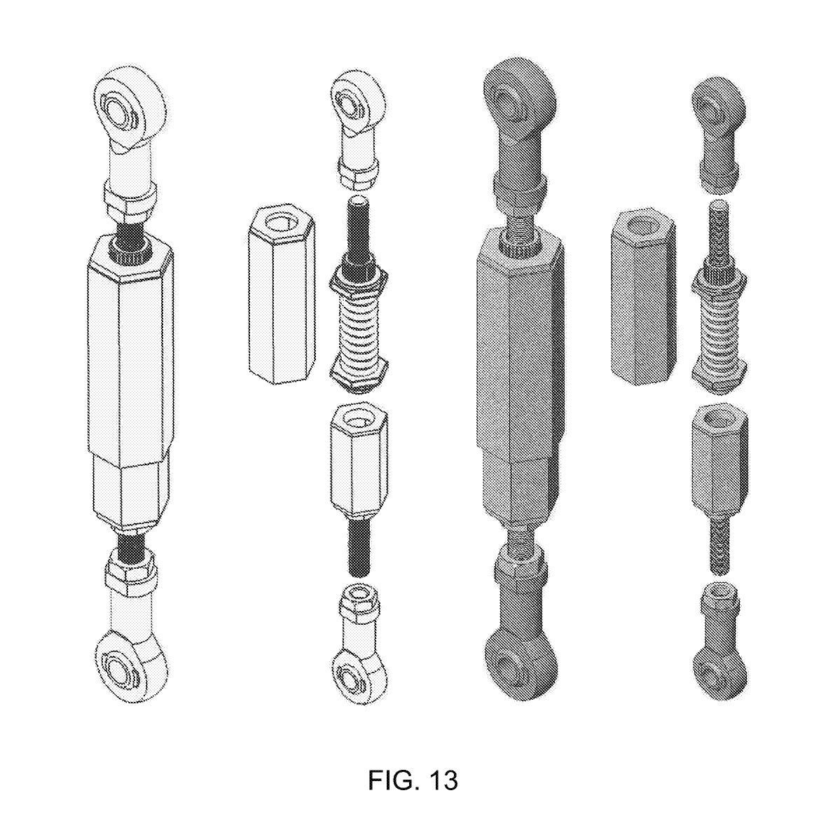

The linkage lower body sub-assembly 102 is preferably made from a round, tube shaped housing that is open ended. The linkage housing may also be square, hexagonal or other shape, as illustrated in FIG. 13. The open end is closed by welding a washer 304 over one of the open ends. The washer 304 shape should match the shape of the housing. The bottom washer may be welded to the threaded rod or a jam nut 310 is used. The top end of the housing is fitted with a flanged washer 304. In an alternate embodiment, the lower body housing could be deep drawn with a hole in the bottom. Optionally, the lower body housing could also be machined. If the lower body housing is machined press fitting is used in preference to threading. Threading is used only with round tubing. The top end has the special flanged washer 304 press fitted to install it. The top end of the housing is threaded 308.

FIG. 4 provides a detailed view of the components of the linkage upper body sub-assembly 104. The linkage upper body sub-assembly 104 is comprised of the upper housing 402 and the end washer 404. The linkage upper body sub-assembly is preferably made from round tube shaped housing that is open ended. The open end is closed on the top end by welding a washer 304 in place. In one embodiment, the upper body housing may be deep drawn with a hole in the top. The open end of the housing is threaded to accept the threaded rod 308.

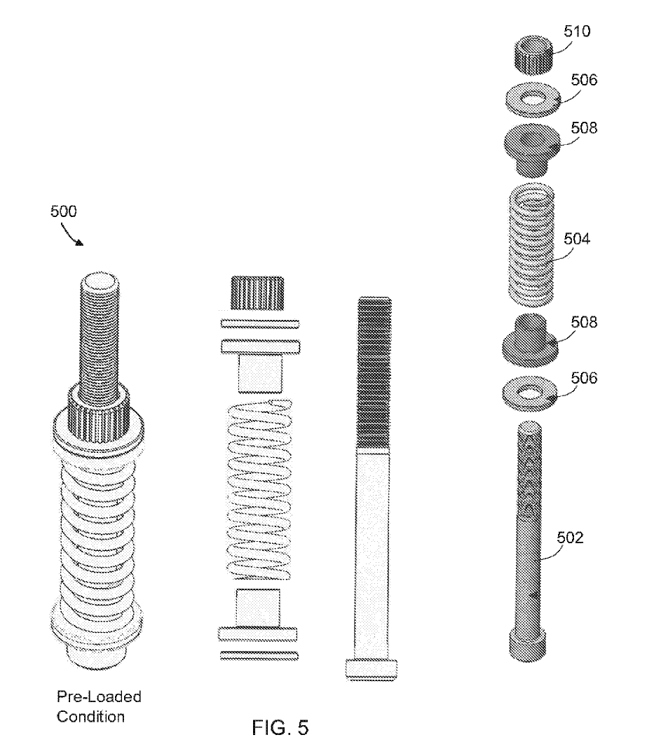

FIG. 5 is an exploded view diagram of the parts comprising the linkage compression spring sliding shaft sub-assembly 206. The linkage compression spring sliding shaft sub-assembly is comprised of a shaft with a threaded end 502 and compression spring 504. Compression spring 504 may be a coil spring, a rubber member, or a pneumatic device. Two base washers 506, one at each end of the linkage compression spring sliding shaft sub-assembly and two flanged bushings 508 are arranged as shown in FIG. 5. A special lock nut 510 retains the completed sub-assembly. Other views in FIG. 5 show the assembly just prior to assembly and the completed assembly in a pre-loaded condition.

The threaded shaft 502 is preferably made of a metallic alloy, for strength and reliability. The compression spring 504 may be a coil spring made of a metal alloy, or it may be a rubber elastomeric material that functions in a manner similar to a coil spring. Furthermore, compression spring 504 may also me a pneumatic or hydraulic device that serves the same function as compression spring 504. The compression spring or equivalent is placed and operates within the two flanged bushings. Washers 506 are placed between threaded shaft 502 head and the lower flanged bushing 508 and the special lock nut 510, as shown in FIG. 5. Flanged bushings 508 are preferably made of plastic polymer or metal composite material. This composite material may be oil or graphite impregnated. The special lock nut 510 pre-loads the assembly and must remain in place. This is accomplished with a lateral screw or plastic locking mechanism (not shown) and prevents special lock nut 510 from loosening.

The bi-directional self-centering linkage is assembled in the following manner: the linkage upper body sub-assembly 104 housing is internally threaded at the open end, allowing it to be combined with the threaded top end of the linkage lower body sub-assembly 102 housing. The hole in the top washer 404 of the linkage upper body sub-assembly 102 allows the special lock nut 510 to pass through it during the compression operation of the bi-directional self-centering linkage.

Threaded shaft 502 has a cylindrical head on the end opposite the threaded portion. The cylindrical head is used to stack a washer 506, followed by the flanged bushing 508, compression spring 504, second flanged bushing 508, second washer 506, and special lock nut 510. This combined compressed stack should equal the inner spacing between the combined linkage lower body sub-assembly 102 and linkage upper body sub-assembly 104.

The linkage compression spring sliding shaft assembly 206 is placed inside the linkage upper housing assembly 204 before attachment to the linkage lower housing sub-assembly 102. This may be done by screwing the assemblies together or by bonding with a strong epoxy. The bi-directional self-centering linkage is completed by attaching a standard female type ball joint end 202 a, b, or by attaching a clevis type end, depending on what is needed to attach to an outside mechanical system.

The construction of the bi-directional self-centering linkage allows the compression spring 504 to be compressed both in extension and shortening actions of the linkage. In addition, the bi-directional self-centering linkage flexibility may be pre-set to a determined pre-load point prior to actuation of the linkage, in one embodiment. In operation, the overall length of the bi-directional self-centering linkage is maintained until a pre-calculated load value is reached. When this value is reached, the bi-directional self-centering linkage begins to lengthen or shorten, depending on the action required by the external mechanical device. Once the overload condition is removed, the bi-directional self-centering linkage returns to original length.

One embodiment provides for fitting the ends of the bi-directional self-centering linkage may be fitted with ball joint ends. In other embodiments, different attachment fittings may be used.

The bi-directional self-centering linkage may be adjusted in length through use of the top and bottom screws. This allows for a custom fit to the particular attachment points and device, for optimum performance.

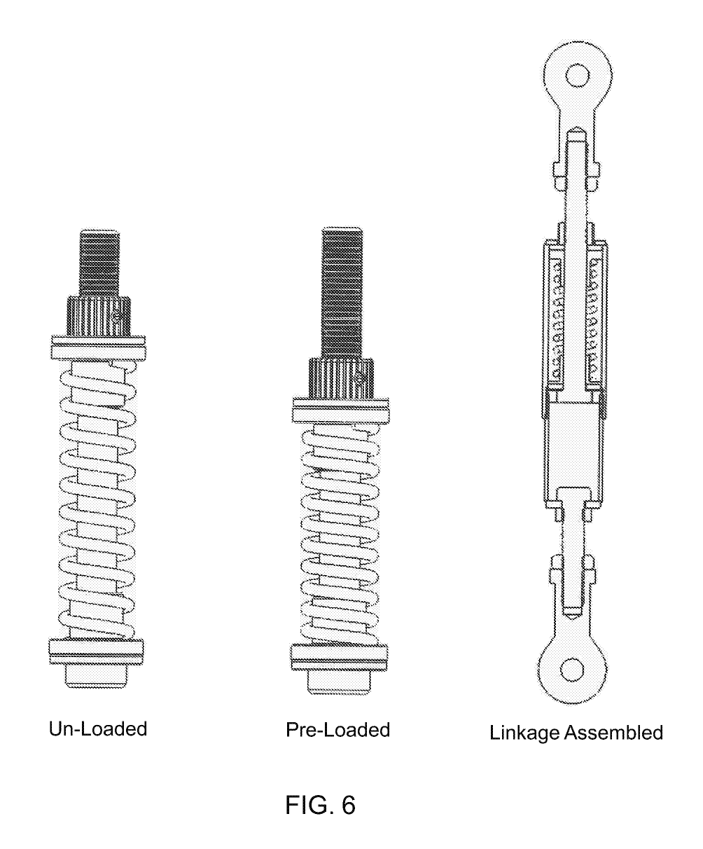

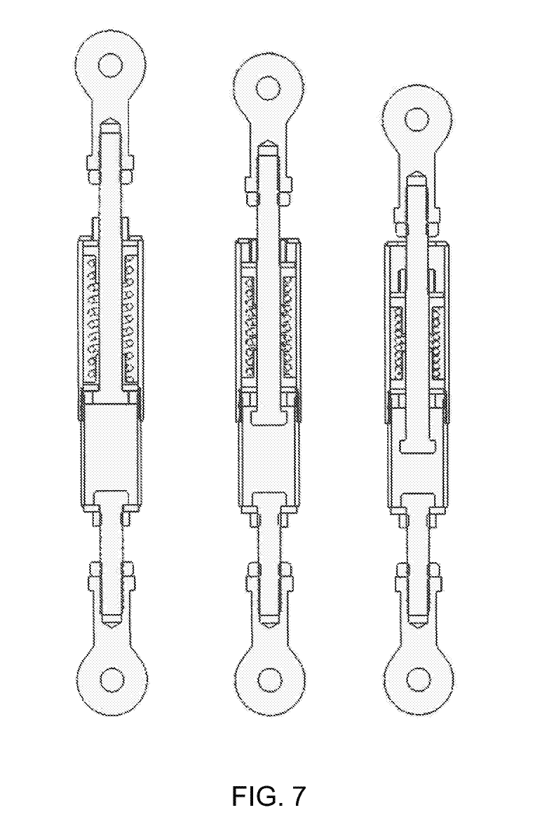

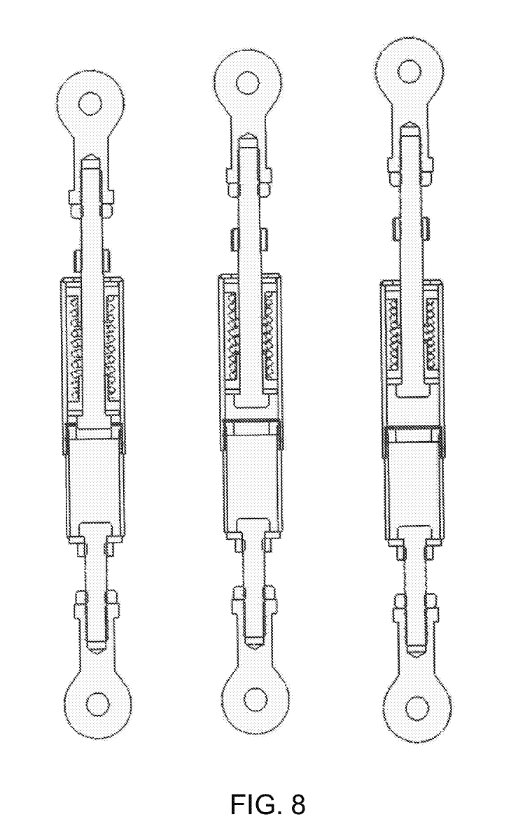

FIG. 6 illustrates the adjustment of the bi-directional self-centering linkage. The linkage compression spring sliding shaft sub-assembly 206 is prepared by first compressing the spring 502 to the desired reload height. This pre-load height is calculated in advance. The linkage compression spring sliding shaft sub-assembly 206 height should be equal to the space inside the linkage body when assembly is complete. This is achieved by adjusting special lock nut 510 until spring 502 is extended inside the bi-directional self-centering linkage without backlash.

FIG. 7 shows a side cut away view of the bi-directional self-centering linkage in compression. When the bi-directional self-centering linkage is compressed and the amount of compression force exceeds the calculated spring pre-load value, the shaft 502 head and special jam nut 310 slide through assembly holes which are slightly larger, thus compressing the spring 502 as shown in FIG. 7. Each view in FIG. 7 shows the compression force being applied, with the illustration on the right demonstrating greatest compression force. FIG. 7 illustrates the bi-directional self-centering linkage becoming shorter as the spring 502 is compressed.

The bi-directional self-centering linkage may also actuate in extension. FIG. 8 illustrates the action in extension. The illustration on the left in FIG. 8 depicts a bi-directional self-centering linkage in an un-extended state. When the bi-directional self-centering linkage is extended, and the pulling or extending force exceeds the calculated spring 502 pre-load value, the shaft 502 head and special lock nut 510 slide through assembly holes, which are slightly larger. This action compresses the spring 502 as shown in the middle and right illustrations in FIG. 8. The bi-directional self-centering linkage becomes longer, as shown in FIG. 8.

A further embodiment of the bi-directional self-centering linkage incorporates shock absorbing materials within the linkage housings, both lower housing 302 and upper body sub-weldment 204. This shock absorbing material softens the abrupt impact of the expansion of the spring to the inside washers when the overload condition is removed.

A still further embodiment incorporates an electromagnetic bushing acting in combination with the assisting compression spring 502.

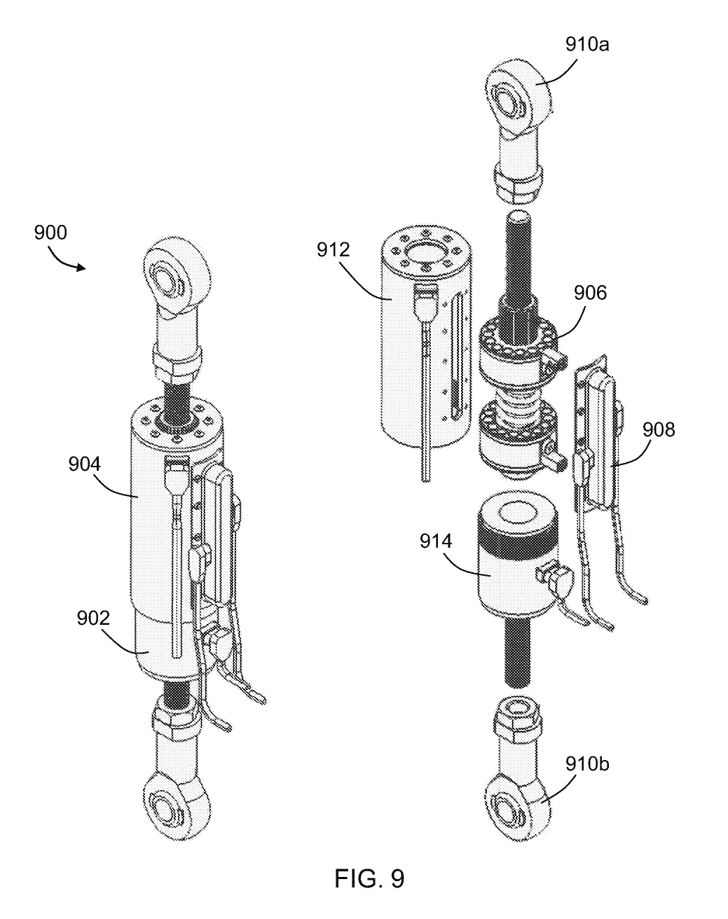

An additional embodiment incorporates magnetic actuation of the bi-directional self-centering linkage. FIG. 9 illustrates this embodiment. The electromagnetic bi-directional self-centering linkage 900 is comprised of a linkage lower body sub-assembly 902 and a linkage upper body sub-assembly 904, and a linkage electromagnetically assisted/activated compression spring sliding shaft assembly 906, as well as a linkage electrical parts assembly 908, the upper body sub-weldment 912 acts as an outer housing for the linkage upper body assembly 904, while the lower body sub-weldment 914 serves as an outer housing for the lower body sub-assembly. Ball joints 910a and b provide attachment points to outside mechanical assemblies.

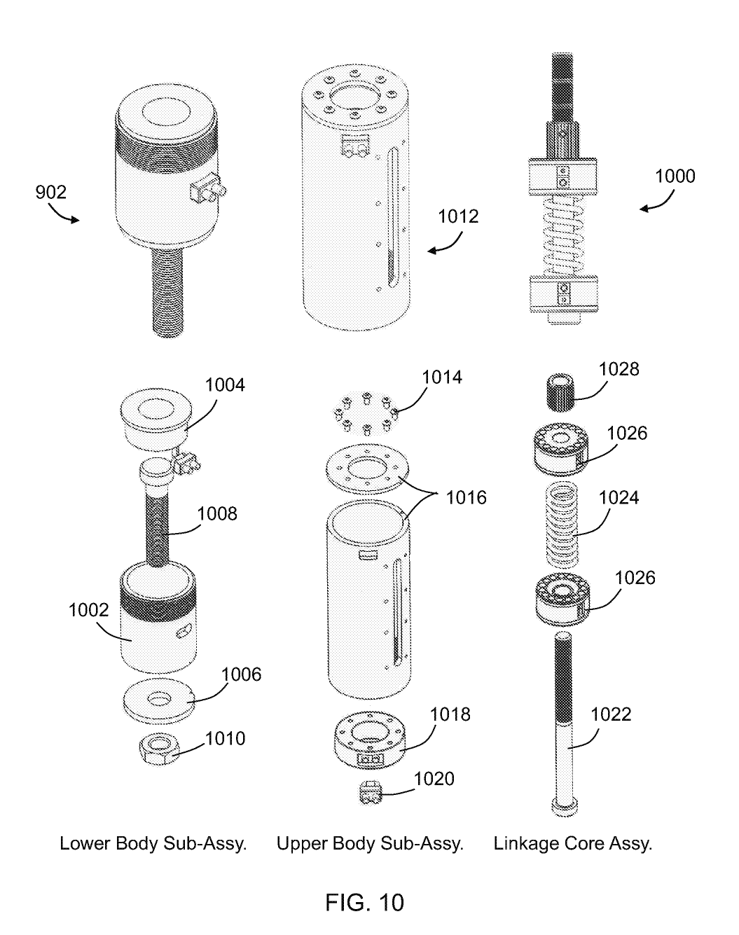

FIG. 10 depicts exploded views of the major sub-assemblies. The linkage lower body sub-assembly 902 consists of the lower housing 1002, top end electromagnetic washer 1004, lower end washer 1004, threaded rod 1008 and nut 1010 or weld.

The upper body sub-assembly 904 consists of an upper housing 1012, end washer 1016, fasteners 1014, electromagnet 1018, and an electric plug 1020.

The electromagnet is contained in the linkage electromagnetically assisted/activated compression spring sliding shaft assembly 1030. This sub-assembly includes a shaft with threaded end 1022, a compression spring (coil, rubber, or pneumatic) 1024, two electromagnetic bushings 1026 and one special lock nut 1028.

The linkage electrical parts assembly 908 is depicted in FIG. 9. The linkage electrical parts sub-assembly 908 consists of a strip rail housing and four electrical cable connectors for delivering electrical inputs to the electromagnetic bi-directional self-centering linkage.

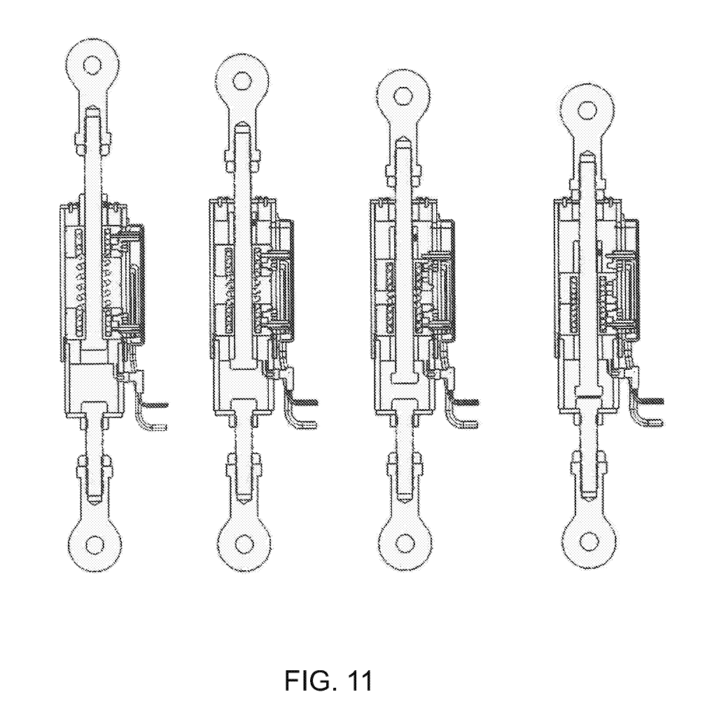

In operation, the electromagnetic bi-directional self-centering linkage may be operated in compression or extension. FIG. 11 depicts operation in compression. The first illustration shows the electromagnetic bi-directional self-centering linkage before any compression force is applied. The electromagnetic bushings are charged to electromagnetically attract with their adjacent lower and upper sub-assembly fixed electromagnets. The compression spring is pre-loaded as described above, however, the electric current feeding the electromagnetic bushings and fixed electromagnets is turned off. The electromagnetic bi-directional self-centering linkage pre-load value may be increased or decreased by activating the electromagnets in a particular order. To increase the pre-load value, adjacent electromagnets are energized to attract one another, thus making it more difficult for the linkage to compress or extend without exceeding the combined spring pre-load and the combined attractive forces of the electromagnets. As the electromagnetic force is applied the linkage compresses, as shown in successive illustrations in FIG. 11.

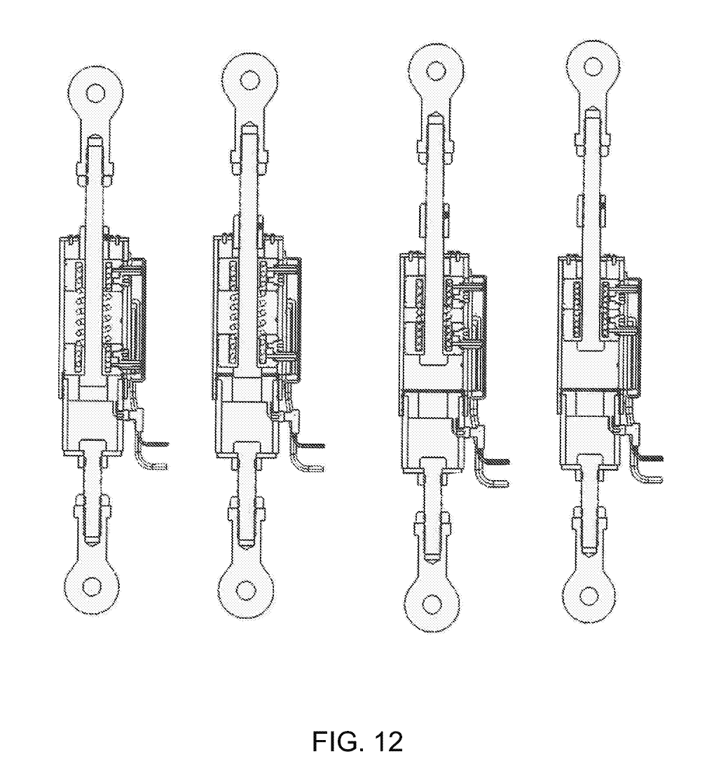

FIG. 12 shows the extension of the electromagnetic bi-directional self-centering linkage. In this case, the electromagnets are energized to repel one another, resulting in a load being applied to compress the pre-loaded spring. This reduces the amount of external load needed to extend or compress the linkage, thus providing an assist to the actuation.

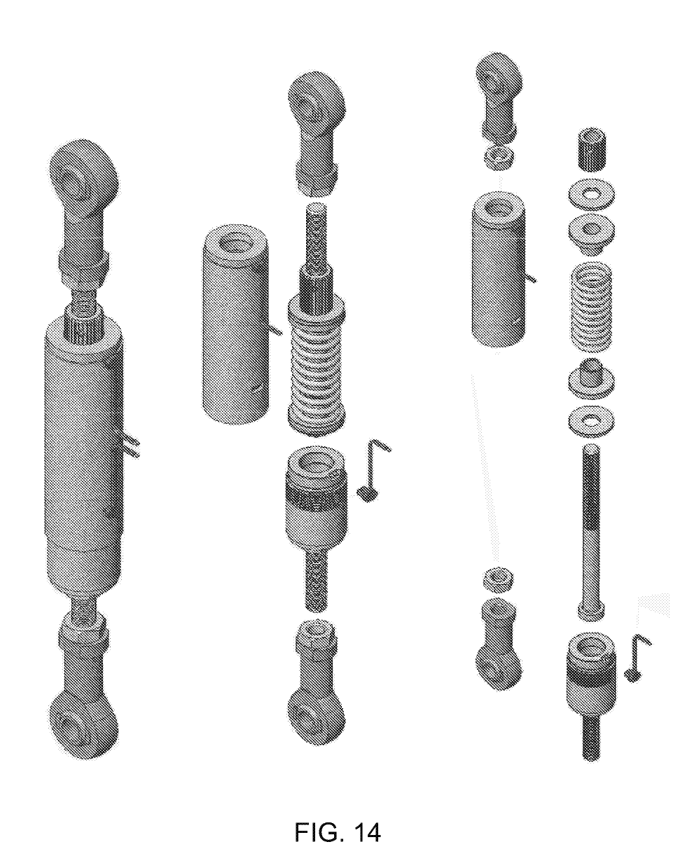

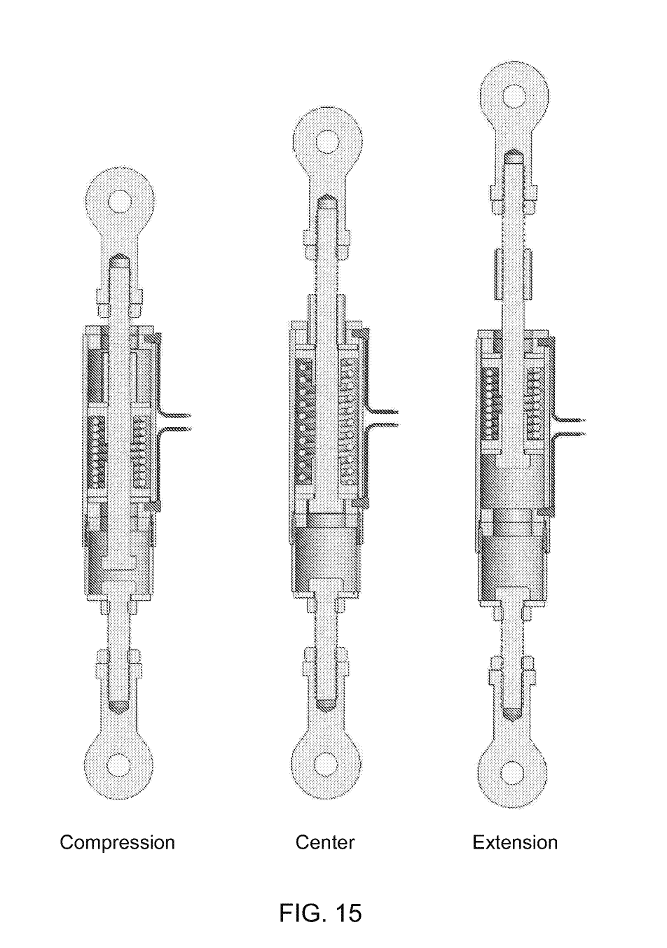

FIG. 14 illustrates a still further embodiment of the bi-directional self-centering linkage. In this embodiment, load cells are placed within the linkage housing. FIG. 14 also provides an exploded view of the assembly of this embodiment. These load cells are connected to electrical signal cables that route an electrical signal of the load value to an outside counter. FIG. 15 provides a cut-away view of the bi-directional self-centering linkage incorporating load cells within the linkage housing. In operation, the bottom load cell registers a positive load in compression loading, with a pre-calibrated load value. The top load cell registers a positive load value during the extension loading state. This embodiment is useful in situations requiring precise determination of the loading characteristics encountered by a design, or where ongoing feedback is needed.

While various embodiments of the present invention have been described above, it should be understood that they have been presented by way of example only, and not of limitation. Likewise, the various diagrams may depict an example architectural or other configuration for the invention, which is done to aid in understanding the features and functionality that may be included in the invention. The invention is not restricted to the illustrated example architectures or configurations, but the desired features may be implemented using a variety of alternative architectures and configurations. Indeed, it will be apparent to one of skill in the art how alternative functional, logical or physical partitioning and configurations may be implemented to implement the desired features of the present invention. Also, a multitude of different constituent module names other than those depicted herein may be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the invention is described above in terms of various exemplary embodiments and implementations, it should be understood that the various features, aspects and functionality described in one or more of the individual embodiments are not limited in their applicability to the particular embodiment with which they are described, but instead may be applied, alone or in various combinations, to one or more of the other embodiments of the invention, whether or not such embodiments are described and whether or not such features are presented as being a part of a described embodiment. Thus the breadth and scope of the present invention should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

A group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the invention may be described or claimed in the singular, the plural is contemplated to be within the scope thereof unless limitation to the singular is explicitly stated.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, may be combined in a single package or separately maintained and may further be distributed across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives may be implemented without confinement to the illustrated examples. For example, block diagrams and their accompanying description should not be construed as mandating a particular architecture or configuration.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

1. A bi-directional self-centering linkage, comprising:
a linkage lower body sub-assembly;
a linkage upper body sub-assembly containing a compression spring sliding shaft sub-assembly, the linkage upper body sub-assembly connected to the linkage lower body sub-assembly; and
attachment points at a free end of the linkage lower body sub-assembly and at a free end of the linkage upper body sub-assembly.

2. The bi-directional self-centering linkage of claim 1, wherein the compression spring sliding shaft sub-assembly includes a nut for pre-loading the compression spring sliding shaft sub-assembly.

3. The bi-directional self-centering linkage of claim 1, wherein the compression spring sliding shaft sub-assembly comprises a threaded shaft fitted with a first washer, a first flanged bushing, a compression spring, a second flanged bushing, a second washer, wherein a nut is used to retain the first washer, the first flanged bushing, the compression spring, the second flanged bushing, and the second washer.

4. The bi-directional self-centering linkage of claim 1, wherein the attachment points are ball joints.

5. The bi-directional self-centering linkage of claim 1, wherein the linkage lower body sub-assembly and the linkage upper body sub-assembly contain shock-absorbing material.

6. A bi-directional self-centering linkage, comprising:
a linkage lower body sub-assembly;
a linkage upper body sub-assembly containing an electromagnetically activated sliding shaft assembly, the linkage upper body sub-assembly connected to the linkage lower body sub-assembly;
a linkage electrical parts assembly attached to the linkage upper body sub-assembly; and
attachment points at a free end of the linkage lower body sub-assembly and at a free end of the linkage upper body sub-assembly.

7. The bi-directional self-centering linkage of claim 6, wherein the electromagnetically activated sliding shaft sub-assembly includes a nut for pre-loading the electromagnetically activated sliding shaft sub-assembly.

8. The bi-directional self-centering linkage of claim 6, wherein the electromagnetically activated sliding shaft sub-assembly comprises a threaded shaft fitted with a first washer, a first electromagnet bushing, a compression spring, a second electromagnet bushing, a second washer, wherein a nut is used to retain the first washer, the first flanged bushing, the compression spring, the second flanged bushing, and the second washer.

9. The bi-directional self-centering linkage of claim 6, wherein the attachment points are ball joints.

10. The bi-directional self-centering linkage of claim 6, wherein the linkage upper body sub-assembly incorporates load cells connected to the linkage electrical parts assembly, the load cells routing an electrical signal of the load value to an external counter.

11. A method for using a bi-directional self-centering linkage, comprising:
calculating a reload height of a spring;
compressing the spring to the pre-load height;
adjusting a sliding shaft sub-assembly height to match the pre-load height inside a bi-directional self-centering linkage body;
adjusting a nut until the spring is extended inside the bi-directional self-centering linkage without backlash;
installing the bi-directional self-centering linkage; and
applying a force to the bi-directional self-centering linkage.

12. A method for using an electromagnetic bi-directional self-centering linkage comprising;
calculating a pre-load height for a spring;
compressing the spring to the pre-load height with no electric current source for electromagnetic bushings and fixed electromagnets;
adjusting the pre-load height by activating the electromagnets to adjust an attraction or repulsion force.

13. A bi-directional self-centering linkage apparatus, comprising;
means for compressing a spring to a calculated pre-load height;
means for adjusting a sliding shaft sub-assembly height to match the pre-load height inside a bi-directional self-centering linkage body;
means for adjusting a nut until the spring is extended inside the bi-directional self-centering linkage without backlash; and
means for installing the bi-directional self-centering linkage.

14. A bi-directional self-centering electromagnetic linkage apparatus, comprising;
means for compressing the spring to a calculated pre-load height with no electric current source for electromagnetic bushings and fixed electromagnets;
means for adjusting the pre-load height by activating the electromagnets to adjust an attraction or repulsion force to a predetermined value; and
means for installing the bi-directional self-centering electromagnetic linkage apparatus after adjustment.
